(19) United States
(12) Patent Application Publication
(10) Pub. No.: US 2004/0149049 A1
(43) Pub. Date: Aug. 5, 2004

(54) Conveyor belt fault detection apparatus and method

(76) Inventors: Larry J. Kuzik, Langley (CA); Ronald M. Ninnis, Vancouver (CA)

Correspondence Address: HUGHES LAW FIRM, PLLC, Suite 201, 2801 Meridian St., Bellingham, WA, 98225, US

(21) Appl. No.: 10/752,453

(22) Filed: Jan. 5, 2004

Related U.S. Application Data
(63) Continuation of application No. 10/191,967, filed on Jul. 9, 2002, now abandoned.
Application No. 10/191,967 is a continuation of application No. 09/523,314, filed on Mar. 10, 2000, now abandoned.
(60) Provisional application No. 60/123,695, filed on Mar. 10, 1999.

(51) Int. Cl. G01L 1/04

(52) U.S. Cl. 73/862.453

(57) ABSTRACT

A testing system for conveyor belts where there is a plurality of testing sections positioned at various locations along the length of the belt to ascertain condition of the belt in these locations. Each test section comprises a radio frequency identification member so that when the test section passes through a monitoring region where there is a monitoring apparatus, the radio frequency identification member transmits an identification signal to indicate the presence of a testing device. The monitoring apparatus transmits an activating signal to the testing device which in turn directs an electric current through a conductive loop extending transversely across the belt. If there is a fault in the belt which severs the wire so that current does not flow, this is detected by the monitoring apparatus to indicate a fault.

### FIELD OF THE INVENTION

A) Background of the Invention

The present invention relates to the general subject of monitoring the condition of large industrial conveyor belts, and more particularly for a system, apparatus and method adapted for detecting rips or splits that occur along the lengthwise axis of the conveyor belt.

B) Background Art

Large industrial conveyor belts are used for a variety of applications, such as carrying ore in mining operations. These belts can be as wide as 0.5 to 3.0 meters, and the total length of such belts can sometimes be as long as one to thirty kilometers or longer.

These large industrial conveyor belts often operate under very adverse conditions and are subject to damage and/or deterioration from a number of causes. One of the more serious failure modes in such conveyor belts is the occurrence of splits along the lengthwise axis of the belt. This could occur, for example, when the belt is punctured and then split along its length by some piece of machinery or a tool. For example, a steel bar might fall onto the belt at a loading point and become jammed with the idler roll mechanism so that it proceeds to cut the belt along its length. The tension of the belt will tend to close such a cut so that, with a load of material, the damage can go unnoticed until the total length of the belt is destroyed.

In such a case, it might take months to obtain and install a new belt, which in the case of a mining operation can result in the loss of millions of dollars a day. Clearly, even a small probability of this breakdown occurring calls for a method to detect such a failure and immediately shut down the system so as to limit the damage.

There are other ways in which a belt might experience failure. For example, the large industrial conveyor belts are often made at the factories in sections, and then on the job site the various sections are spliced together. In larger belts, these are commonly reinforced with steel cables running the length of the belt, and it is necessary to make the splice by having a section where the cables overlap with one another. If the splice is not properly made, failure can begin in this area. Also, the steel cables are subject to corrosion, so that localized weaknesses can occur. Quite often when the failure can occur initially in one area, this results in adjacent areas being stressed to a higher degree, and thus the fault spreads further. If left unnoticed, there can occur catastrophic results.

With regard to the problem of a split occurring in a belt, one prior art method of detecting this is to place strands of electrically conductive wire (often in loops) transversely across the belt. Then, when a split does occur, this will break the wire so that it will no longer conduct. Then, when the wire or loop of wire passes by a sensing station using electromagnetic sensing techniques, this break in the wire or wire loop can be detected.

One of the problems in protecting against the effects of such rips is knowing the location of the fault. One prior art way of accomplishing this is by means of a belt displacement meter in the form of a rotation counter (i.e. a pulley) by establishing and maintaining a database of the intervals between the loops and given a starting point, a microprocessor tells the monitor when to expect the next one to arrive. If no signal is transmitted through the belt at the predicted time, it is then assumed that a loop has been broken and the conveyor system is shut down. (Also the location is identified and recorded.) However, this system has a problem in that it is the lack of a signal which indicates that a fault may be present.

However, the lack of a signal may be due to one of various causes. For example there may be a defect in the monitoring apparatus. Or the belt may have slid, so that if the rotating pulley is used to ascertain the location, this would not give an accurate reading.

A search of the prior art has disclosed a number of U.S. patents related to generally this problem. These are the following:

U.S. Pat. No. 4,541,063 (Doljack) shows a rip detection and monitoring system for a conveyor belt. There are a number of antennas which are embedded in the belt and extend transversely across the belt. At a rip detection station 11 there is a transmitter plate 12 and a receiver or detector plate 13, these being on opposite sides of the belt. As the antenna 10 passes by, the signal from the transmitter 12 travels through the antenna to the location of the detector plate 13. If the antenna is damaged, then no signal is received at the detector plate 13. This invention is intended to minimize nuisance shutdowns caused by the signal delivered to the downstream circuitry being below a predetermined magnitude or being non-existent. As indicated in column 5, line 16, the rotation or output of the motor 6 is monitored with a roller with a conventional tachometer, and then correlates such progress information. Upon missing an “event” the system may promptly stop the motor to shut down the conveyor belt. The patent relates mainly to the detecting the various signals to interpret which of these would indicate damage of a sufficient magnitude to see if the belt should be shut down.

U.S. Pat. No. 4,464,654 (Klein) shows a rip detection device where there are three antennas 10 capable of capacitive coupling with a transmitter and receiver. The antennas 10 are embedded in the belt, and appear to operate in much the same manner as the above noted patent (U.S. Pat. No. 4,541,063).

U.S. Pat. No. 4,447,807 (Klein et al.) shows essentially the very same system that is shown in U.S. Pat. No. 4,541,063. The gist of the patent is that the frequency of the AC signal used to detect the integrity or lack of the same is desirably in a frequency between about 25 KHz to about 200 KHz and preferably in the range of 50 KHz to 100 KHz.

U.S. Pat. No. 4,087,800 (Lee) shows a rip detection apparatus for a conveyor belt which can best be seen in FIG. 3. There is a sensor circuit 14 which comprises the coil 16 which is connected at its opposite ends to the loop 15 which extends transversely to the belt. When there is a rip and the wire 15 is broken, as described in column 5, beginning on page 31, as the inductor coil 16 with the broken wire 15 passes by the inductor coil 21 of the alarm system, the inductor coil 16 will be in resonance with its “distributed capacitance” and in “matched resonance” with the “primary circuit” of the alarm circuit 20.

U.S. Pat. No. 3,792,459 (Snyder) shows a conveyor belt rip detector, and a basic system shown in FIG. 3. This appears to be very similar to that shown in the Doljack patent (U.S. Pat. No. 4,541,063) which issued about 11 years later. There are a number of single conductors 20 which extend across the belt and these are activated by a transmitting oscillator or plate 30 and a detector plate 31 on the opposite side received its signal. Again, this patent deals primarily with the circuitry in detecting the rip.

U.S. Pat. No. 3,742,477 (Enadnip) shows two embodiments of a damaged conveyor belt detector. In FIG. 1, there is shown a magnet 5 that causes a current to flow in coil 4, which is one of many that are imbedded in the belt. The current flow induces a current in the coil 6 that causes the relay 8 to hold a motor switch closed as long as a series of “okay” signals are received. The second embodiment is shown in the other figures in which there is a primary coil 16 that causes a current flow in the embedded loop 25 to a feedback coil 17 that detects a signal indicative of the condition of the embedded wire loop. As indicated in column 3, lines 3-10, as soon as it has sensed no current flowing in one of the loops, the circuit opens the normally closed switch 30 which shuts off the power from the power line 31 to the belt drive motor, thereby turning off the motor, stopping the belt and preventing any further lengthening of the tear.

U.S. Pat. No. 3,656,137 (Ratz) shows an embedded wire loop 4 that is placed across the tuned circuit 18, so that when the loop breaks or the tuned circuit is not shorted, it will change the output of the oscillator. As indicated in column 1, line 49 this causes a relay to disconnect the motor which drives the conveyor.

U.S. Pat. No. 3,636,436 (Kurauchi et al.) shows a means for detecting fissures in a belt. There is an exciting coil A and several detecting coils fixed below the belt. Embedded in the belt are a receiving coil and several output coils connected together. The arrangement is such that the alignment of the coil B with a coil A is longitudinal, while the alignment of coil A to the coil C is transverse. Where there is a break in either set of wires going between the exciting coil A and the other two coils B and C, the detection circuit sounds an alarm, such as the buzzer 54, and, as indicated in column 4, line 32 “at the same time, if desirable, the output signal from the relay 51 will operate another relay 56 to open switch 57 to cease the operation of motor 58 driving the conveyor belt”.

### SUMMARY OF THE INVENTION

The present invention comprises a belt monitoring system capable of monitoring a belt having a lengthwise axis to ascertain a condition of the belt at various belt locations along the lengthwise axis and also identify the belt location at which the condition of the belt is ascertained.

The system comprises an identification and testing section which in turn comprises a plurality of identification and testing devices mounted to the belt at spaced test locations along the lengthwise axis of the belt. Each of the identifying and testing devices has an identifiable test location on the belt at which the identification and testing device ascertains the condition of the belt. It further has a capability of providing a test output indicating condition of the belt at its related test location on the belt. Further, each identification and testing device has an identifying portion to provide an identification output that identifies the location of the identifying and testing device on the belt.

There is also a monitoring apparatus positioned to monitor testing of the belt in a monitoring region. The monitoring apparatus is arranged to receive the output of the identification and testing device in the monitoring region and to receive an identification output of the identification and testing device. Thus, a condition of the belt at various belt locations and the location of such condition can be ascertained. In the preferred form, the identification and testing device is passive and is caused to be activated by an external power source when the identification and testing section is at the monitoring region. In the preferred form, the identification and testing system is activated by electromagnetic energy to cause said identification and testing section to provide said condition output and said identification output.

Each identification and testing section comprises an identification device and a testing device. The identification device responds to an input of electromagnetic energy to produce an identification output. The testing device is arranged to respond to electromagnetic energy to provide its test output. The identification device is operable to provide the identification output independently of the testing device so as to be able to provide identification of its related identification and testing section, independently of any output of the testing device.

Also, in the preferred form, the testing device has an “on/off” output, where a detectable output is provided to show a no fault condition, and there is a lack of a detectable output when the testing device responds to a fault condition.

In one form, the identification device comprises a transmitting portion capable of transmitting an encoded identification signal. This identifying device can comprise a radio frequency identification chip.

In a preferred form, the test section comprises an electrically conductive component extending along an area of the belt. The test device is arranged to transmit an electromagnetic signal corresponding to a no fault condition when said electrically conductive component remains conductive, and to send no signal when said electrically conductive component is not conducting.

The testing device in a specific form comprises a test antenna responsive to electromagnetic energy to cause current to flow through the electrically conductive component, and the monitoring section further comprises an electromagnetic transmitter to direct electromagnetic energy to the test antenna to the monitoring region.

The electrically conductive component comprises a wire portion which leads from the antenna transversally across the belt and is connected across the test antenna so that when the test antenna is activated, an electric current flows through the electrically conductive component, and when the electrically conductive component is severed no electric current flow through the test antenna or the electrically conductive component.

In the specific configuration, the monitoring apparatus has an antenna portion capable of transmitting electromagnetic energy to the testing device, and the identification device in the monitoring region and also to receive electromagnetic transmissions from each of said testing device and said identification device. The system is arranged so that the identification device arrives at the monitoring region and is activated by the antenna portion of the monitoring apparatus, the identification device transmits to the monitoring apparatus an identification signal which indicates to the monitoring apparatus that the test device has arrived or is about to arrive at the monitoring location, and also to provide electromagnetically identification of its related testing device.

The identifying device has a transmitting and receiving identification antenna which is at a transmitting and receiving location on the belt. The test device also has a transmitting and receiving antenna portion on the belt generally longitudinally aligned with the antenna portion of the identification device, and there is a transmitting and receiving portion of the part of the antenna portion f the monitoring apparatus in general alignment with the transmitting and receiving antenna portions of the identification device and the testing device.

In a preferred form, the test device comprises an electrically conductive component which extends from the antenna portion of the testing device transversally across the belt to form a closed loop connection with the antenna portion of the test device. Thus, when the electrically conductive loop is not severed, the antenna portion of the test section conducts electricity therethrough and in the loop, and when the electrically conductive loop is severed, current does not flow through the antenna portion of the test section. The antenna portion of the monitoring apparatus is responsive to electromagnetic transmission from the antenna portion of the testing device to ascertain a conductive or nonconductive condition of the testing device. The monitoring apparatus is arranged to receive the identification transmission from the identification device and relate this to a related transmission of the testing device or nonexistence of a related transmission from the testing device. In the circumstance where there is an identifying transmission from the identification device and no transmission from the related testing device, the monitoring apparatus perceives a fault condition.

In one embodiment of the present invention the testing device also has a second identifying device which is responsive to current flow through the testing device when activated from the monitoring apparatus. The second identification device provides an electromagnetic signal which is transmitted through the antenna portion of the testing device to transmit identification of the testing device to the monitoring apparatus.

In another embodiment, there is provided a capacitor in the electrically conductive component of the testing device which functions to establish a resonant frequency in the electrically conductive component and electromagnetic energy transmitted by the antenna portion of the monitoring apparatus matches the resonant frequency of the electrically conductive component. In another arrangement, there is at least one identification device on one side of the belt and a second identification device on the opposite side of the belt. Thus, each of the two sides of the belt is able to pass through the monitoring section to transmit an identifying signal indicating that the testing device is in the monitoring region. In another arrangement, the test section has an antenna coil portion on each side of the belt. Thus, the test section is activated by the antenna portion of the monitoring apparatus whether one side or the other side of the belt passes through the monitoring region.

In another embodiment a capacitor is placed in series with the test coil so that when there is a break in the test loop, the circuit becomes resonant to send a strong signal indicating a break. Thus there is positive logic in the test signal to indicate a fault.

In the method of the present invention, the testing device and the monitoring device are provided as described above. The monitoring apparatus is positioned at the monitoring region, and the belt is cause to trammel through the monitoring region. At such time as each identification device passes by the monitoring region, it delivers a signal to the monitoring apparatus that that particular identification device has arrived at the monitoring region and that a test signal (which can be an “on/off” signal) will arrive shortly, or in another embodiment should have already arrived. The test device corresponding to that identification device passes through the monitoring region to deliver its test signal.

Other features of the present invention will become apparent from the following detailed description.

### BRIEF DESCRIPTIONS OF THE DRAWINGS

FIG. 1 is a somewhat schematic top plan view of a first embodiment of the present invention;

FIG. 1A is a side elevational view of FIG. 1, and also illustrating the monitoring apparatus of the first embodiment;

FIG. 2 is an isometric view similar to FIG. 1, showing a second embodiment;

FIG. 3 is a view similar to FIGS. 1 and 2, showing yet a third embodiment;

FIG. 4 is a view similar to the previous figures showing a fourth embodiment;

FIG. 4A is a side elevation view of FIG. 4, further showing the monitoring apparatus of the fourth embodiment;

FIG. 5 is a schematic view similar to the prior figures, and showing yet a sixth embodiment;

FIG. 6 is a schematic view similar to the prior figures showing a sixth embodiment; and

FIG. 7 is a view similar to the prior FIGS. 1-6 showing yet a seventh embodiment.

### DESCRIPTION OF THE PREFERRED EMBODIMENTS

A first embodiment of the present invention is shown in FIGS. 1 and 1A. The system 10 of this first embodiment of the present invention is used in connection with a conveyor belt 12 (only a portion of this belt being shown in the plan view of FIG. 1 and the side elevational view of FIG. 1A). This belt 12 is in this preferred embodiment a large industrial conveyor belt, having a body made of a fabric, multi-layer fabric or steel as a tension member and covered rubber and/or synthetic rubber. For the larger belts having greater width and extending for greater lengths, longitudinally aligned steel cables may be embedded in the body of the belt 12 to give greater tensile strength.

For purposes of description, the belt 12 can be considered as having a lengthwise axis 14 (also called a longitudinal axis 14), a transverse horizontal axis 16 extending between the side edges 18 of the belt 12, and a vertical axis 20 (perpendicular to both the longitudinal and transverse axis). The belt has an upper surface 22 and a lower surface 24.

In the system 10 of the present invention, there is a plurality of test locations 26 at longitudinally spaced intervals along the length of the belt. There is a plurality of identification and testing sections 28, each of which is located at a related test location 26. (For convenience, the identification and testing section shall simply be referred to as the “testing section 28” in the subsequent text).

The system 10 further comprises at least one monitoring section 30 which is positioned at a monitoring location 31 in proximity to the belt 12. Desirably, this monitoring section 30 is at a fixed location so that as the belt travels by the monitoring station, each of the testing sections 28 pass in sequence by the monitoring section 30.

The monitoring section 30 comprises a transmitter/receiver 32, which in turn comprises a transmitting and receiving antenna 34, and a control circuitry component 36 operatively connected to the antenna 34. The monitoring section 30 also comprises a computer to in turn control signals to the control circuitry 36 and also a computer 38 to perform related monitoring and correlating functions as will be described later herein.

The testing section 28 comprises identification device 40 and a testing device 42. These can either be separate from one another or combined with one another in some way. In this first embodiment, the identification device 40 and the testing device 42, while having functional relationships, are separate from one another.

In the preferred form, the identification device 40 is a tag or chip 44 which is commonly used in radio frequency identification (RIFID). The chip or tag (ASIC) typically consists of a coil, a capacitor, and a microcircuit (including memory) bonded inside a covering. The tag is often produced in the form of a thin disc a few centimeters in diameter. The tag 44 contains encoded information which is in this embodiment an identification number or some other designation used to identify its related test location 26 and its related testing device 42.

Such tags 44 are commonly used in connection with a read/write head. When brought within range (typically ten to thirty centimeters of the tag), the read/write head is able to both read from and write into the tag memory. Both the information and the energy to power the tag circuit is carried electromagnetically, commonly at a frequency of 125 kHz. In the present embodiment, the tag 44 simply maintains its identification information encoded therein. For example, if there are 100 test locations 26, the tags 44 associated with these 100 test locations would have for example, designations from 00 up to 99. Each tag 44 is passive, in that it does not have its own power source. Rather, it has to be activated by electromagnetic energy being induced into the coil of the tag 44 which then enables it to transmit an electromagnetic signal in which its identification number is encoded.

The tag is desirably embedded in the belt at the time the belt is being manufactured or retrofit in existing belts, and it would be positioned adjacent to one of the side edges 18 and desirably proximate to the surface of the belt (generlaly the lower surface 24) which would normally be an unloaded surface of the belt. The tag 44 should be somewhat flexible (not brittle) and it should be sufficiently rugged to withstand impacts. Also, since it will desirably be placed in the belt at the time the belt is being formed in the manufacturing process, it would be necessary to be able to survive the vulcanizing temperatures to which the belt is subjected (e.g. as high as 150° C. or 300° F. for up to an hour). Also, it is preferred that a bond (i.e. glue, epoxy) causing the vulcanized belt rubber to bond to the newly embedded tag.

The aforementioned antenna 34 of the monitoring section 30 is located a short distance below the belt surface 24 (i.e. between ten and forty centimeters) so as to be in alignment with the path of travel of each of the tags 44 that pass through the monitoring region. As will be described more fully later herein, the antenna 34 is continuously energized from the control circuitry 36 to supply electromagnetic energy at a frequency which matches the resonance frequency (tuned frequency) of the tag 44. Thus, when the tag 44 comes into proximity with the antenna 34, it becomes energized so that it transmits a return signal which is encoded with its particular identification number designation or other cite specific data.

The aforementioned testing device 42 comprises in this first embodiment a test antenna 46 which is aligned with, and positioned rearwardly of, the identification tag 44. As can be seen in FIG. 1, the forward path of travel of the belt 12 is indicated by the arrow 48, and thus it can be seen that after the tag 44 has passed over the antenna 34 of the monitoring section 30 to transmit its identification signal, its related test antenna 46 of the testing device 42 then passes over the monitoring antenna 34.

The testing section 42 further comprises a fault detecting portion 50 that is operatively connected to its test antenna 46 to be energized by the same. More specifically, the fault detecting portion 50 comprises a wire section 52 which in this preferred embodiment is a loop of an electrically conductive wire which comprises a first wire 54 having a first end 56 connected to a first end of the test antenna 46, and extends therefrom across the width of the belt 12 to the opposite far side 18 of the belt 20. The far end 58 of the wire 54 connects to a joining wire section 60 at the far side 18 of the belt 12 and connects to an end 62 of a second return wire 64 (with a resistor 65) which extends transversally from the far side 18 to the near side 18, with this second wire being spaced a moderate distance (e.g. a half foot or a foot) rearwardly from the first wire 54. Then this second wire 64 connects at 66 to a second end of the test antenna 46 opposite to the connecting locations of the first wire 54.

Thus, it can be seen that when the test antenna 46 of the testing device 42 moves to the location of the monitoring antenna 34, the monitoring antenna 34 energizes the test antenna 46 to cause current to flow through the wire loop 52 (i.e. through the first wire section 54, thence through the adjoining wire section 60 and on return path through the second wire 64 back to the testing antenna 46). This flow of current through the test antenna 46 is sensed by the monitoring apparatus 30. Thus, this flow of current through the test antenna 46 indicates that the belt portion at that particular test location has not been damaged (e.g. by a longitudinally extending rip or slit) so as to break either or both of the wire lengths 54 and 64.

To describe now the overall operation of the present system, as indicated above, the belt 12 has along its entire length a plurality of testing sections 28, each at a related test location 26, with these test locations 26 being at spaced intervals along the length of the belt 12. The monitoring section 30 is desirably placed at a stationary location adjacent to the belt 12 and in a position accessible to the surface 22 or 24 of the belt.

Let us assume that there is no rip, split or other damage to the belt 12, so that each of the testing sections 28 are intact (i.e. more specifically, the wire section 52 of each testing section 28 is intact and the other components are operating satisfactorily). Let us now assume that one of the test sections 28 is traveling toward the monitoring location 31 of the monitoring section 30. As indicated previously, the monitoring antenna 34 is a transmitting/receiving antenna which is continuously energized to as to create an energizing magnetic field at a frequency matching that of the identification tags 44.

As each tag 44 reaches the location of the monitoring antenna 34, the tag 44 becomes energized so that the tag 44 then sends an electromagnetic signal which is encoded with its identification number. This identifying signal is received by the monitoring antenna 34 and in turn transmitted through its control circuitry 36 to the computer 38.

This identification signal transmitted to the monitoring section 30 can be termed an “announcement signal” which gives the message “I am here, and you should expect that shortly a testing device will transmit a test signal to indicate that the testing device is intact”.

The test antenna 46 is just a short distance (e.g. 0.5 to 2 meters) behind the identification tag 44, so the test antenna would normally reach the location of the monitoring antenna 34 shortly after the tag 44 has passed over the monitoring test antenna 34.

When the test antenna 46 reaches the monitoring region of the monitoring apparatus 30, the electromagnetic energy of the monitoring antenna 34 causes an oscillating current to flow through the test antenna 46 and through the wire section 52. This flow of current through the antenna 46 is sensed through the monitoring antenna 34, and (as indicated above) this information is transmitted through the control circuitry 36 and to the computer 38. The information which the computer now has is that at this particular test has been monitored and no fault has been found. Then the same operations is performed as the subsequent test sections 28 passed by the monitoring location 31.

Now let us consider the situation where a rip has developed at one of the test locations 26 on the belt 12 so that either or both of the wires 54 and 64 of that test location has been severed. When that particular test section 26 reaches the monitoring location 31, the tag 44 of that test section which has been damaged transmits its announcement signal to the monitoring apparatus 30, which tells the monitoring apparatus 30 “I am tag number 27; I am here; and you can expect an ‘I'm okay’ test signal from test device number 27 to follow very shortly’”. However, in this instance, since the wire section 52 has been damaged so that current does not flow through the test antenna 46 of the damaged test section 28, the computer 38 immediately recognizes that this lack of a test signal following the announcement signal indicates a malfunction of the test section 28. Further, due to the construction and operation of the test section, this malfunction would very likely mean that the circuit of the antenna 46 and the wire section 52 has been damaged in some manner.

Thus, not only has the likelihood of damage been detected, but the location of that damage has been identified. While this first embodiment has been described as having only one monitoring location, it should be understood that there may be several of these monitoring apparatus at different locations along the belt 12. The location of the damage could be quickly ascertained simply by identifying one of the test locations which is immediately nearby, and since the relative location of all the test locations 26 are known, the location of the test location indicating the fault can be immediately determined.

From the above, it can readily be deduced that one of the key advantages of the present invention is that positive logic is used. The conditions for an intact and for a damaged belt are both indicated by active signals (rather than simply by an absence of a signal). More specifically, for the belt at the test location to be intact, two signals are received, namely the identification signal and very shortly after the test signal. If the identification signal is received and this test signal is not, this indicates the fault.

There may also be the situation where for some reason the announcement signal is not received. The chances of the identifying tag 44 being damaged are considered to be rather remote, but beyond this, there may be some malfunctioning in the monitoring equipment which would cause the announcement signal not to be received properly. Let us assume that this is the case, but that the testing device 42 is functioning. In this instance the monitoring apparatus 30 would quite possibly receive the test signal, but it would not be correlated with an identification signal. This would in turn give an indication that while the belt might not be damaged, the monitoring system may be damaged.

There are various ways in which the monitoring section 30 can determine whether or not there is current flowing through the test antenna 46. One way in which this can be accomplished is to monitor the electromagnetic field created by the monitoring antenna 34. If current is flowing through the test antenna 46, since this current through the antenna 46 is taking energy from the field created by the monitoring antenna 34, this will modify the magnetic field generated by the monitoring antenna 34. This could either be sensed by a sensing coil or a Hall effect sensor, or by monitoring the amplitude of the current in the antenna.

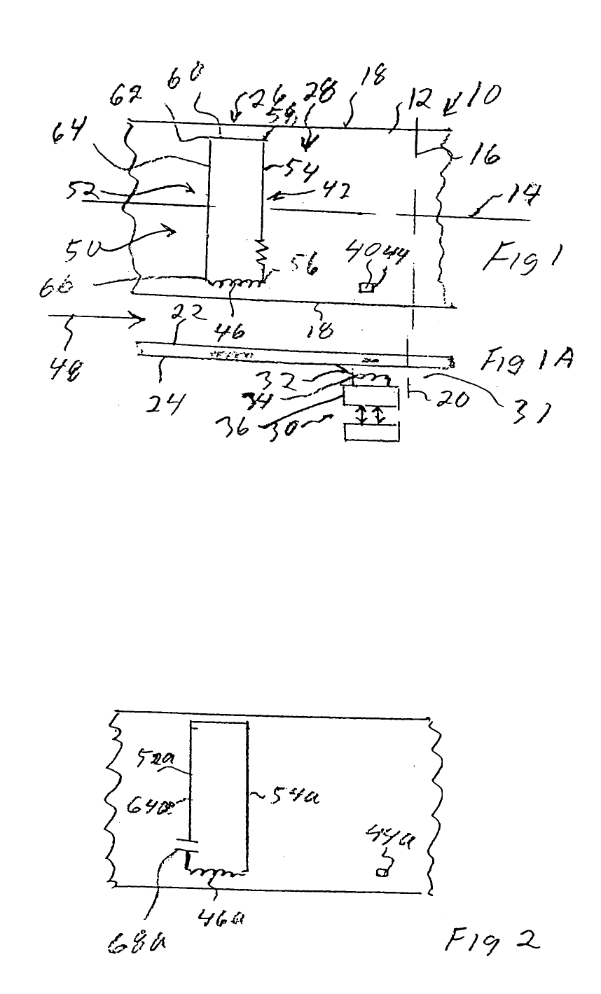

A second embodiment of the present invention is shown in FIG. 2. Components of this second embodiment which are similar to components of the first embodiment will be given like numerical designations, with an “a” suffix, distinguishing those of the second embodiment. This second embodiment differs from the first embodiment in that the test circuit of the testing device 42 is modified to place a capacitor and a resistor in the loop 52 so that the capacitor and resistor are in series with the antenna 46 (the antenna 46 functioning as an inductance coil) thus creating an LC resonant circuit which is designed to resonate at the appropriate frequency of 125 kHz at which the identifying tag 44 resonates.

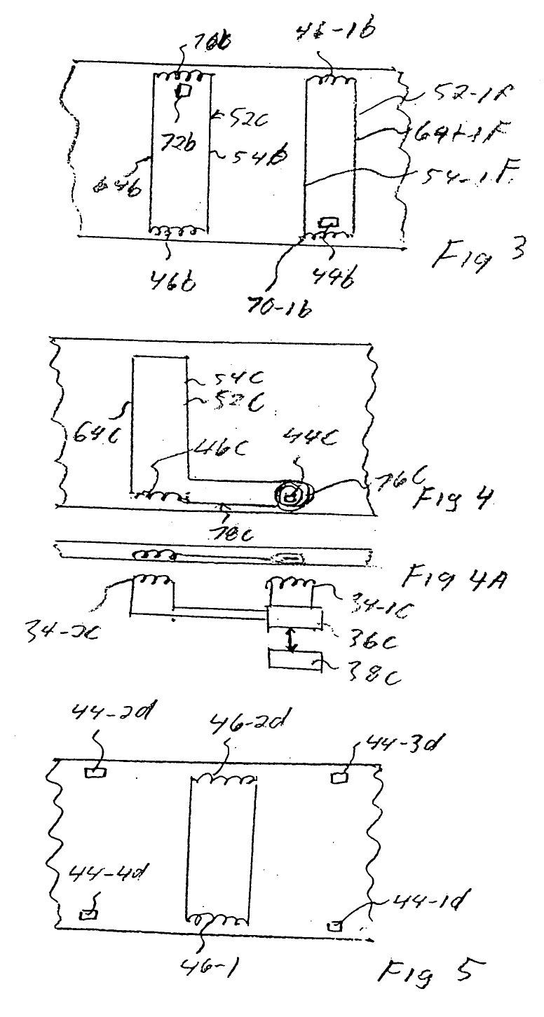

Thus, as can be seen in FIG. 2, there are the basic components of the identification tag 44a, the monitoring antenna 34a, the control circuit 36a and the computer 38a (not shown). In like manner there is the testing antenna 46a and the two wires 54a and 64a which complete the test loop. The only difference is that the capacitor 68a has been placed at the wire 64a to provide the LRC resonant circuit. Present analysis indicates that this would provide greater sensitivity. A third embodiment of the present invention is shown in FIGS. 3 and 3A. Components of this third embodiment similar to the first embodiment will be given like numerical designations, with a “b” suffix distinguishing those of the third embodiment.

This third embodiment differs from the prior two embodiments in that the test apparatus 42 has been designed so that the signal developed by the test apparatus 42b is encoded to also identify the particular test location 26b of the testing section 28b. Also the components are arranged so that the system can operate so that either side edge 18 of the belt can pass through. In other respects, the system 10b remains substantially the same as the system 10 of the first embodiment.

With reference to FIG. 3, it can be seen that the joining wire 60 (which in the first embodiment simply made a connection between the far ends of the two wires 54 and 64) has been replaced by a coil 70b, and also there is a second identification chip or tag 72b which is activated by the coil 70b. Also there is a second loop 52-1F, comprising two additional transverse wires 54-1F and 64-1F.

To describe the operation of this third embodiment, when the testing section 28 is approaching the monitoring region 31, the identification tag 44b functions as in the first embodiment, namely to send an identifying signal to the antenna 34b which in turn is picked up by the computer 38b. Then when the belt travels a short distance further so that the antenna coil 46b moves into proximity with the monitoring antenna 34b, as in the first embodiment, current is-generated in the test antenna 46b.

The current flow through the wire 54b and through the coil 70b which activates the second identification tag or chip 72b. The tag 72b in turn produces a signal into the coil 70b which travels through the return wire 64b to the antenna 46b to in turn transmit an identifying signal back to the transmitting/receiving antenna 34b of the monitoring section 30b. This signal emitted from the test antenna 46b thus not only indicates that there is no break in the test loop (thus indicating that the belt 12 is intact at that location), but also gives further identification of the identifying the test location 26b. Also the test procedure involves ordinary RFID methods.

It can be seen that if the belt is installed in a reverse position, or if the monitoring apparatus 30 is placed on the opposite side, the tag 72b becomes the active identification indicator and the test loop 52-1F becomes the active test loop.

FIG. 4 shows a fourth embodiment of the present invention. Components of the first embodiment which are similar to one or more of the prior components will be given like numerical designation with a “c” distinguishing those of this fourth embodiment of FIG. 4 differs in that instead of having the single/receiving antenna 34, there is a first transmitting/receiving antenna 34-1c and a second receiving antenna 34-2c. As in the prior embodiments, there is the identifying chip or tag 44c, and there is the test antenna 46c. Also, there is the wire loop 52c, comprising the two transverse wire members 54c and 64c.

In this fourth embodiment, at the location of the chip 44c there is a coil 76c which is positioned in proximity to the tag 44c so that when the transmitting antenna 34-1c activates the chip or tag 44c, in addition to sending the announcing signal to the transmitting/receiving antenna 34-1c, it also activates the coil 76 with an encoded signal that is transmitted through a wire 78c through the coil 46c, thence through the two transverse wires 54c and 64c, and back to the opposite end of the coil 76c to close the loop. Thus, when there is no break in either of wires 54c or 64c, the current will flow through he coil 46c to send an encoded signal to the receiving antenna 34-2c. However, if there is a break in either of the wires 54c and 64c, the current will not pass through the antenna 46c.

Thus, in operation, let us assume that the test device 42c is intact. In this instance, when the tag 44c comes in proximity with the monitoring antenna 34-1c to be activated thereby, there is an immediate transmission of the announcing signal from the chip 44c to the sending/receiving coil 34-1c. This would give a signal that in almost the very same time frame there should be a second signal received by the receiving antenna 34-2c. if this does not happen, then this would indicate that there is a fault in the test device 46c, and that quite likely one or both of the wires 34c and 64c have been severed.

FIG. 5 shows a fifth embodiment of the present invention. Components of this fifth embodiment which are similar to or the same as, components of one or more of the prior embodiments will be given like numerical designations, with a “d” suffix distinguishing those of this fifth embodiment.

Now this fifth embodiment differs from the prior embodiments in that there is not a single test antenna 46, as in the first embodiment of FIG. 1, but rather two such antennas located on opposite sides of the belt, one being designated 46-1d and the other being designated 46-2d. The two ends of each antenna 46-1d and 46-2d are attached to one another by the transverse wires 54d and 64d. Also, instead of having the single identification tag 44, there are four such tags designated 44-d through 44-2d, 44-3d and 44-4d.

One of the advantages of this fifth embodiment is, as in the third embodiment, that the testing apparatus will function no matter which way the belt is installed. It sometimes happens that the belt is installed backwards, so that the operating components of the test system are not on the same side as the monitoring apparatus. If this occurs in this fifth embodiment, the testing system is still operable.

A further advantage of this system is (as in the third embodiment) that no matter which way the belt is installed, there will be two identifying tags which would pass through the monitoring region. Thus, there is the announcement identification signal that very shortly after the announcement signal the test device will arrive at the location of the activating antenna 34d. Then after the test antenna 46-1d or 46-2d has passed by the monitoring antenna 34d, a second identifying tag, either 44-3d will pass by the monitoring antenna 34d and will give a signal which indicates “a test coil 46-1d or 46-2d should have passed by just a very short time before. If this has not occurred, then the computer 28d would detect a fault condition.

It is to be understood that these same features of the fifth embodiment could be incorporated in the other embodiment.

A sixth embodiment of the present embodiment is illustrated in FIG. 6. Components of this sixth embodiment which are similar, or the same as, components of one or more of the prior embodiments will be given like numerical designations, with a “e” distinguishing those of the sixth embodiment. In the sixth embodiment there is a first transmitting/receiving antenna 34-1e on one side of the belt 3e, and there is a second receiving antenna 34-2e transversely aligned with the first monitoring antenna 34-1e. There is the identification tag 44e and surrounding this identification tag is a coil 82e, and opposite ends of this coil 82e are attached respectively, to the transverse wires 84e and 86e. The far ends of these two wires 84e and 86e join to a coil 88e imbedded in the belt 12 and adjacent the far side 12e of the belt. When the tag 44e reaches the location of the monitoring antenna 34-1e, it is activated to send an announcing signal back to the transmitting/receiving antenna 34-1e. At the same time, a signal is imparted into the surrounding coil 82e which in turn activates the coil 88e which then sends an announcing signal to the far side receiving antenna 34-2e.

Then when the test coil 46-1e reaches a location of the monitoring antenna 34-1e, a current is induced in the coil 46-1e which in turn travels through the wires 54e and 64e to in turn cause a current to flow through a far side test coil 46-2e. Since the two antenna coils 46-1e and 46-2e are transversally aligned with one another, as are the monitoring antennas 34-1e and 34-2e, the antenna coil 46-2e will be aligned with the antenna 34-2e, and the current flowing through the coil 46-2e will be sensed by the sensing apparatus associated with the receiving antenna 34-2e.

Likewise, with current flowing through the coil 46-1e when it is at the location of the transmitting/receiving antenna 34-1e, this will be sensed by the apparatus associated with the monitoring antenna 34-1e also to verify that current is flowing through the wire lop made up of the wires 54e and 64e.

The antennas 34-1e and 34-2e will be connected to the same computer system. Thus, there is a redundancy in the signals which are transmitted, and also on the reception of such signals.

Thus, it can be seen that if there is a break in any one of the four wires 84e, 86e, 54e, and 64e, this can be sensed. If one of the wires 84e or 86e is damaged so as to be severed, so that no signal is received at the monitoring antenna 34-2e, this would indicate one of the wires 84e and 86e is severed. Yet, there will be the announcing signal transmitted to the transmitting/receiving antenna 34-1e. Then if there is no signal generated in either of the monitoring antennas 84-1e or 84-2e, this would indicate when the testing antennas 46-1e and 46-2e are at the monitoring locations, this would indicate a break in either the wire 54e or 64e. On the other hand, it may be that one or the other of the antennas 34-1e or 34-2e are malfunctioning in some manner so that the signal may not be sensed on one monitoring antenna but in the other. In this case, the fault would then be surmised not to be damage to the testing device 42e, but rather in the monitoring equipment.

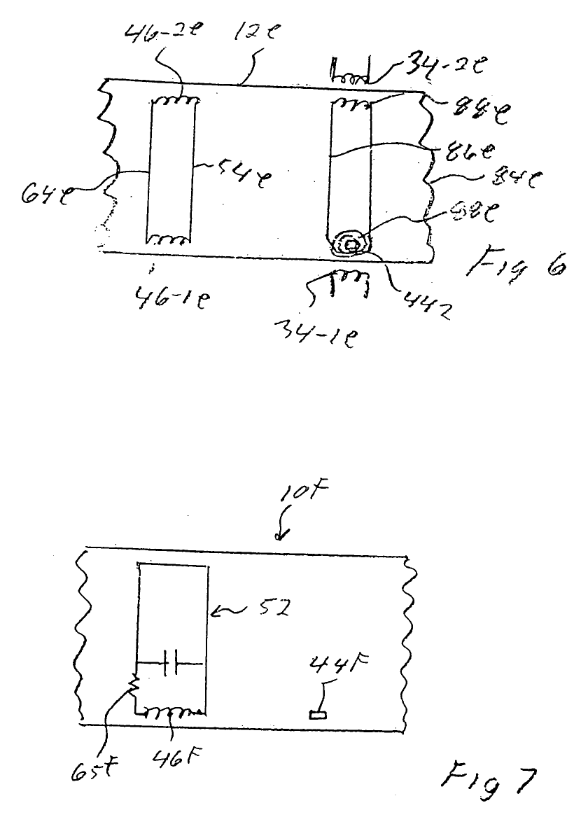

A seventh embodiment of the present invention is shown in FIG. 7. Components of this seventh embodiment which are similar to components disclosed earlier will be given an “f” designation distinguishing those of this seventh embodiment.

This seventh embodiment is substantially the same as the first embodiment, except that a capacitor has placed in parallel with the test coil or antenna.

Identification coil 44f, the test coil 46f, the conductive wire loop 52, and the monitoring section 30f. Further, there is a resistor 65f in the wire 64f which with the wire 54f and the connecting wire 60f form the loop 52f. Then there is a capacitor 90f connected in parallel with the test coil or antenna 46f.

In operation, when the electric loop 52 is intact (not broken), the loop 52 essentially shorts out the capacitor 90F. Thus, no significant voltage can develop across the capacitor, and the system cannot resonate. However, when the loop 52 is severed, the effect is that the circuit formed of the coil 46f, the resistor 55f, and the capacitor 90f resonates and gives a strong signal. Thus this is “positive logic” in that the test section responds to indicate a fault when a strong fault signal is transmitted, which is in contrast to the other embodiments where the lack of a signal from the test device indicates a fault.

It is to be understood that various modifications could be made to the present invention without departing from the basic teachings thereof.

Therefore, I claim:

1. A belt monitoring system capable of monitoring a belt having a lengthwise axis to ascertain a condition of the belt at various belt locations along the lengthwise axis and also identify the belt location at which the condition of the belt is ascertained, said system comprising:
a) an identification and testing section comprising a plurality of identification and testing devices mounting to the belt at spaced test locations along the lengthwise axis of the belt, each identifying and testing device having an identifiable test location on the belt at which the identification and testing device ascertains a condition of the belt, each identification and testing device being capable of providing a test output indicating condition of the belt at its related test location on the belt, each identification and testing device having an identifying portion to provide an identification output that identifies the location of the identifying and testing device on the belt;
b) the monitoring apparatus positioned to monitor testing of the belt in a monitoring region, said monitoring apparatus being arranged to receive the output of the identification and testing device in the monitoring region and to receive an identification output of the identification and testing device,
whereby a condition of the belt at various belt locations and the location of such condition can be ascertained.

2. The system as recited in claim 1, wherein said identification and testing device is passive and is caused to e activated by an external power source when the identification and testing section is at the monitoring region.

3. The apparatus as recited in claim 2, wherein said identification and testing system is activated by electromagnetic energy to cause said identification and testing section to provide said condition output and said identification output.

4. The system as recited in claim 3, wherein said identification and testing section comprises an identification device and a testing device, said identification device responding to an input of electromagnetic energy to produce said identification output, and said testing device being arranged to respond to electromagnetic energy to provide said test output, said identification device being operable to provide said identification output independently of said testing device so as to be able to provide identification of its related identification and testing section, independently of any output of the testing device.

5. The system as recited in claim 4, wherein the testing device has an “on/off” output, where a detectable output is provided to show a no fault condition, and there is a lack of a detectable output when the testing device responds to a fault condition.

6. The system as recited in claim 5, wherein said identification device comprises a transmitting portion capable of transmitting an encoded identification signal.

7. The system as recited in claim 6, wherein said identifying device comprises a radio frequency identification chip.

8. The system as recited in claim 5, wherein said test section comprises an electrically conductive component extending along an area of said belt, and the test device is arranged to transmit an electromagnetic signal corresponding to a no fault condition when said electrically conductive component remains conductive, and to send no signal when said electrically conductive component is not conducting.

9. The system as recited in claim 8, wherein said testing device comprises a test antenna responsive to electromagnetic energy to cause current to flow through electrically conductive component, and said monitoring section further comprises an electromagnetic transmitter to direct electromagnetic energy to the test antenna at the monitoring region.

10. The system as recited in claim 9, wherein said electrically conductive component comprises a wire portion which leads from said antenna transversally across said belt and is connected across the test antenna so that when the test antenna is activated, an electric current flows through said electrically conductive component, and when said electrically conductive component is severed, no electric current flows through the test antenna or the electrically conductive component.

11. A belt monitoring system capable of monitoring a belt having a lengthwise axis to ascertain a condition of the belt at various belt locations along the lengthwise axis and also identify the belt location at which the condition of the belt is ascertained, said system comprising:
a) a plurality of test devices mounted to the belt at the spaced test locations along the lengthwise axis of the belt, each test device having an identifiable test device location on the belt at which the test device ascertains condition of the belt, each test device being capable of providing a test output indicating condition of the belt in its related test location on the belt;
b) a plurality of identification devices, each of which is mounted to the belt for travel therewith and associated with a related testing device to provide an identification output that identifies its related test device location;
c) a monitoring apparatus positioned to monitor testing within a monitoring region, said monitoring apparatus being arranged to receive an output of the test device in the monitoring region and to receive an identification output from the identification device related to the test device whose output is being received and relate the output of the test device to the identification of the test device
whereby condition of the belt and the location of such condition can be ascertained at various locations along the length of the belt.

12. The system as recited in claim 11, wherein said monitoring apparatus has an antenna portion capable of transmitting electromagnetic energy to said testing device and said identification device in the monitoring region, and also to receive electromagnetic transmissions from each of said testing device and said identification device.

13. The system as recited in claim 12, wherein the identification device is arranged so that when the identification device arrives in the monitoring region and is activated by the antenna portion of the monitoring apparatus, said identification device transmits to the monitoring apparatus an identification signal which indicates to the monitoring apparatus that the test device has arrived or is about to arrive at the monitoring location, and also to provide electromagnetically identification of its related testing device.

14. The system as recited in claim 13, wherein said identifying device has a transmitting and receiving identification antenna portion which is at a transmitting and receiving location on said belt, and said test device has a transmitting and receiving antenna portion on said belt generally longitudinally aligned with the antenna portion of the identification device, and there is a transmitting and receiving portion of the part of the antenna portion of the monitoring apparatus in general alignment with the transmitting and receiving antenna portions of the identification device and the testing device.

15. The system as recited in claim 14, wherein said test device comprises an electrically conductive component which extends from the antenna portion of the testing device transversely across the belt to form a closed loop connection with said antenna portion of the test device, whereby when the electrically conductive loop is not severed, the antenna portion of the test section conducts electricity therethrough in said loop, and when the electrically conductive loop is severed, current does not flow through the antenna portion of the test section, the antenna portion of the monitoring apparatus being responsive to electromagnetic transmission from the antenna portion of the testing device to ascertain a conductive or nonconductive condition of the testing device.

16. The system as recited in claim 14, wherein said monitoring apparatus is arranged to receive the identification transmission from the identification device and relate this to a related transmission of the testing device or nonexistence of a related transmission from the testing device, and in the circumstance where there is an identifying transmission from the identification device and no transmission from the related testing device, the monitoring apparatus perceives a fault condition.

17. The method as recited in claim 16, wherein the antenna portion of the monitoring apparatus responds to a condition of current flow in the antenna portion of the testing device and the antenna portion of the testing device or no flow of current through the antenna portion of the testing device to ascertain a fault condition by detecting of magnetic field variations due to the flow or non-flow of current through the antenna portion of the testing device.

18. The system as recited in claim 16, wherein said testing device also has a second identifying device which is responsive to current flow through the testing device when activated from the monitoring apparatus, said second identification device providing an electromagnetic signal which is transmitted through the antenna portion of the testing device to transmit identification of the testing device to the monitoring apparatus.

19. The system as recited in claim 16, wherein there is provided a capacitor in said electrically conductive component which functions to establish a resonant frequency in the electrically conductive component and electromagnetic energy transmitted by the antenna portion of the monitoring apparatus matches the resonant frequency of the electrically conductive component.

20. The system as recited in claim 1, wherein there is at least one identification device on one side of the belt and a second identification device on the opposite side of the belt, whereby each of two sides of the belt is able to pass through the monitoring region to transmit an identifying signal indicating that the testing device is in the monitoring region.

21. The system as recited in claim 20, wherein the test section has an antenna coil portion on each side of the belt, whereby the test section is activated by the antenna portion of the monitoring apparatus whether one side or the other side of the belt passes through the monitoring region.

22. A method of monitoring a belt having a lengthwise axis to ascertain a condition of the belt at various belt locations along the lengthwise axis and also identify the belt location at which the condition of the belt is ascertained, said method comprising:
a) Mounting a plurality of identification and testing devices to the belt at spaced test locations along the lengthwise axis of the belt, each identifying and testing device having an identifiable test location on the belt at which the identification and testing device ascertains a condition of the belt, and with each identification and testing device being capable of providing a test output indicating condition of the belt at its related test location on the belt;
b) mounting to the belt for each testing device an identifying device to provide an identification output that identifies the location of the identifying and testing device on the belt;
c) providing monitoring apparatus positioned to monitor testing of the belt in a monitoring region;
d) moving the belt through the monitoring region so that the monitoring apparatus receives an identification output of each identification and testing device, and an output of each related testing device.
